(19) United States
(12) Patent Application Publication
(10) Pub. No.: US 2015/0046729 A1
(43) Pub. Date: Feb. 12, 2015

(54) SEMICONDUCTOR APPARATUS AND CONTROL METHOD THEROF

(71) Applicant: RENESAS ELECTRONICS CORPORATION, Kawasaki-shi (JP)

(72) Inventors: Kazuki FUKUOKA, Kawasaki-shi (JP); Kazuo OTSUGA, Kawasaki-shi (JP)

(21) Appl. No.: 14/454,543

(22) Filed: Aug. 7, 2014

(30) Foreign Application Priority Data
Aug. 8, 2013 (JP) 2013-165192

(51) Int. Cl. G06F 1/32; G06F 13/24

(52) U.S. Cl. CPC G06F 1/3296; G06F 13/24
USPC 713/320

(57) ABSTRACT

First and second processing units execute a binary program. A temperature sensor measures a temperature of a first processing unit. A temperature detection unit outputs a first interrupt instruction when the temperature measured by the temperature sensor exceeds a first value. A bus exchanges data between the first and second processing units. In response to the first interrupt instruction, the control unit interrupts execution in the first processing unit, migrates first data that is necessary for resuming the execution of the binary program from the first processing unit to the second processing unit, and controls the second processing unit to resume the execution of the binary program in the second processing unit. A power control unit interrupts power supply to the first processing unit after the first data is migrated to the second processing unit.

### CROSS-REFERENCE TO RELATED APPLICATIONS

This application is based upon and claims the benefit of priority from Japanese patent application No. 2013-165192, filed on Aug. 8, 2013, the disclosure of which is incorporated herein in its entirety by reference.

### BACKGROUND

The present invention relates to a semiconductor apparatus and a control method of the semiconductor apparatus, and for example, to a semiconductor apparatus and a control method of the semiconductor apparatus that is used in a mobile device.

In a semiconductor apparatus, a CPU (Central Processing Unit) performs arithmetic processing. Thus, generated heat involved in the arithmetic processing increases in a high-speed CPU. Therefore, when highly-loaded arithmetic processing continues, a temperature of the CPU rises, likely causing a failure and thermal runaway.

In order to prevent such a phenomenon, there is, for example, a proposed configuration that includes a graphic controller (GPU) with high generated heat and a graphic controller (GPU) with low generated heat and switches CPUs according to a change in the temperature (Japanese Unexamined Patent Application Publication No. 2011-14155). In this configuration, a temperature of the external graphic controller with a high processing capacity and high generated heat is monitored. When the temperature of the external graphic controller is greater than a predetermined value, the built-in graphic controller with low generated heat performs display control processing. The generated heat is suppressed by reducing an operation frequency and a duty cycle of the external graphic controller. Thus, the thermal runaway of the external graphic controller is prevented.

Further, there is a proposed configuration that indirectly monitors a temperature by monitoring leak current (Japanese Unexamined Patent Application Publication No. 2004-280378). In a semiconductor apparatus, the greater the processing capacity and the temperature of a CPU, the greater the leak current of the CPU. Therefore, it is possible to indirectly monitor the temperature of the CPU by monitoring the leak current. Thus, in this configuration, when a leak current value of a CPU with high peak performance exceeds a predetermined value, a CPU with low peak performance performs arithmetic processing.

Further, there is a proposed configuration that switches a control mode of a processing unit according to a temperature inside an image processing apparatus that is equipped with the processing unit including a CPU (Japanese Unexamined Patent Application Publication No. 2011-131472). In this configuration, when the temperature inside the image processing apparatus is greater than a predetermined value, processing is switched from a first CPU with high generated heat to a second CPU with low generated heat. Accordingly, an increase in the temperature of the processing unit is suppressed.

### SUMMARY

However, the present inventors have found out that there are following problems in the above-mentioned configurations. In the configuration of Japanese Unexamined Patent Application Publication No. 2011-131472, arithmetic processing is switched from the CPU with high generated heat to the CPU with low generated heat according to an increase in the temperature. However, only switching the CPUs leads to a situation that requires the switching to wait until program in processing is completed. In this case, the temperature may excessively increase until the processing of the program is completed. Further, in the configuration of Japanese Unexamined Patent Application Publication No. 2011-14155, when the program in processing is forcibly terminated, the program processing that has been terminated must be re-executed from the beginning after switching the CPU. Therefore, the arithmetic processing is delayed, thereby restricting an operation of a device to which the CPUs are mounted.

Other issues and new features will be apparent from descriptions and attached drawings of the specification.

An aspect of the present invention is a semiconductor apparatus that includes: a first processing unit that executes a binary program; a second processing unit that is capable of executing the binary program the same as the binary program executed by the first processing unit; a temperature sensor that measures a temperature of the first processing unit; a temperature detection unit that outputs a first interrupt instruction when the temperature measured by the temperature sensor exceeds a first value; a bus that exchanges data between the first processing unit and the second processing unit; a control unit that, in response to the first interrupt instruction, interrupts execution in the first processing unit, migrates first data from the first processing unit to the second processing unit, and controls the second processing unit to resume the execution of the binary program, in which the first data is necessary for resuming the execution of the binary program; and a power control unit that blocks power supply to the first processing unit after the first data is migrated to the second processing unit.

Accordingly, it is possible to provide a semiconductor apparatus and a control method of the semiconductor apparatus that can prevent an increase in a temperature while suppressing interruption of arithmetic processing.

### BRIEF DESCRIPTION OF THE DRAWINGS

The above and other aspects, advantages and features will be more apparent from the following description of certain embodiments taken in conjunction with the accompanying drawings, in which:

FIG. 1A is a block diagram schematically showing a configuration of a semiconductor apparatus 100 according to a first embodiment;

FIG. 1B is a block diagram showing in more detail the configuration of the semiconductor apparatus 100 according to the first embodiment;

FIG. 2 is a flowchart showing an operation of the semiconductor apparatus 100 according to the first embodiment;

FIG. 3 is a graph showing a relationship between a temperature of a first CPU core unit C1 and processing capacity of the semiconductor apparatus 100;

FIG. 4 is a flowchart showing an interrupt procedure of arithmetic processing in the first CPU core unit C1;

FIG. 5 is a flowchart showing a data migration procedure from the first CPU core unit C1 to a second CPU core unit C2;

FIG. 6 is a flowchart showing a procedure to power off the first CPU core unit C1;

FIG. 7 is a flowchart showing a procedure to switch execution of arithmetic processing from the second CPU core C2 to the first CPU core C1;

FIG. 8 is a flowchart showing an operation of a semiconductor apparatus 200 according to a second embodiment;

FIG. 9 is a block diagram schematically showing a configuration of a semiconductor apparatus 300 according to a third embodiment;

FIG. 10 is a circuit diagram showing a configuration example of a temperature sensor 2 that is configured using a bandgap circuit; and

FIG. 11 is a block diagram schematically showing a configuration of a semiconductor apparatus 400 according to a fourth embodiment.

### DETAILED DESCRIPTION

Hereinafter, embodiments shall be explained with reference to the drawings. The same components are denoted by the same reference numerals throughout the drawings, and a repeated explanation shall be omitted as necessary.

### First Embodiment

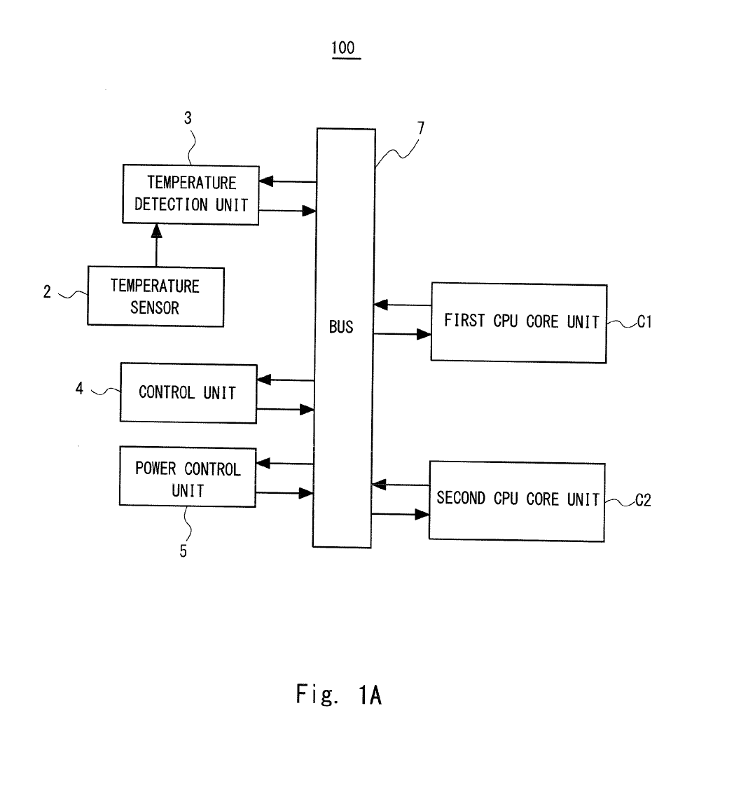

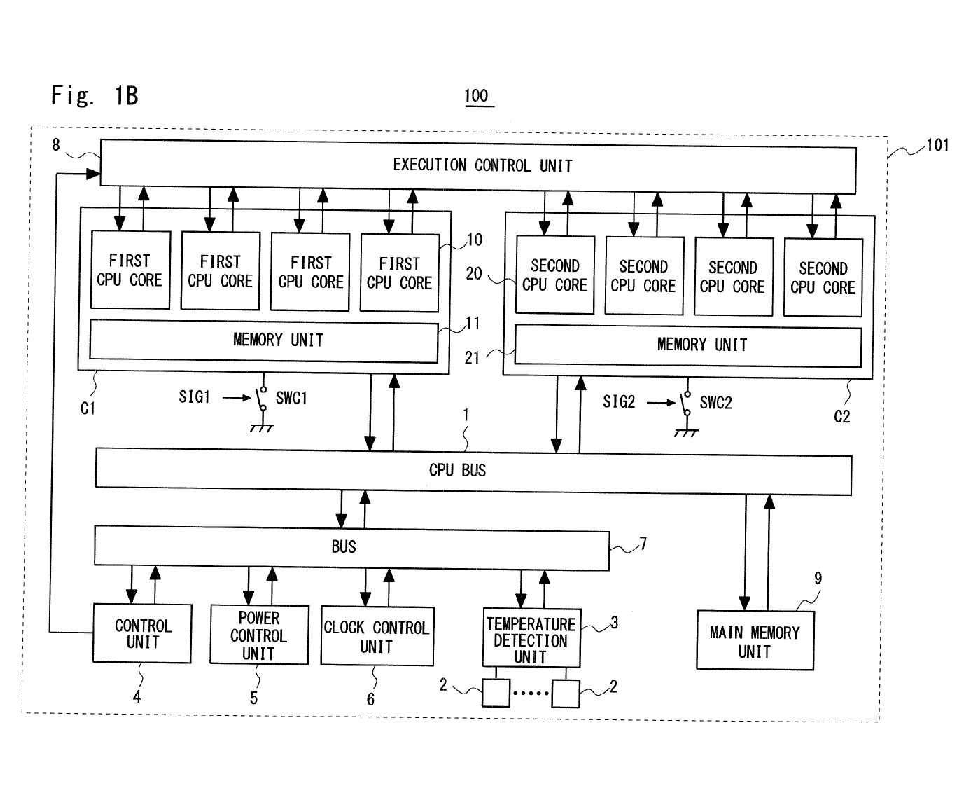

Firstly, a semiconductor apparatus 100 according to a first embodiment shall be explained. FIG. 1A is a block diagram schematically showing a configuration of the semiconductor apparatus 100 according to the first embodiment. FIG. 1B is a block diagram showing in more detail the configuration of the semiconductor apparatus 100 according to the first embodiment. As shown in FIG. 1B, the semiconductor apparatus 100 includes a first CPU core unit C1, a second CPU core unit C2, a CPU bus 1, temperature sensors 2, a temperature detection unit 3, a control unit 4, a power control unit 5, a clock control unit 6, a bus 7, an execution control unit 8, and a main memory unit 9 that are formed above the same semiconductor chip 101. Further, as shown in FIG. 1A, the CPU bus 1 can be included in the bus 7 and configured as one bus. Note that the first CPU core unit C1 shall also be referred to as a first processing unit. The second CPU core unit C2 shall also be referred to as a second processing unit.

The first CPU core unit C1 has an arithmetic processing capacity greater than that of the second CPU core unit C2. As the first CPU core unit C1 generates a temperature higher and operates faster than the second CPU core unit C2, usually the first CPU core unit C1 is composed of a transistor with a great leak current. Note that the first CPU core unit C1 and the second CPU core unit C2 are compatible and can operate on, for example, the same programming language, the same algorithm, and the same binary codes (binary program) based on the data set of the same format.

The first CPU core unit C1 includes one or a plurality of first CPU cores 10 and a memory unit 11. FIG. 1 shows an example where the first CPU core unit C1 includes one first CPU core 10. The first CPU core 10 is a CPU core capable of performing high-speed arithmetic processing. The first CPU core 10 is composed of a transistor that performs an ON/OFF operation at a high speed. In general, as a high-speed MOS transistor has a low threshold voltage (Vth) and a thin gate oxide film, leak current is relatively large. The memory unit 11 is a high-speed cache memory for temporarily storing information of the main memory unit 9. A power switch SWC1 is provided in the first CPU core unit C1 and controlled to be ON/OFF by a power control signal SIG1 from the power control unit 5.

The second CPU core unit C2 includes one or a plurality of second CPU cores 20 and a memory unit 21. FIG. 1 shows an example where the second CPU core unit C2 includes one CPU core 20. The second CPU core 20 is a CPU core that is configured to consume power less than the first CPU core 10 does. That is, the second CPU core 20 is composed of a transistor that performs an ON/OFF operation at a speed lower than the speed at which the transistor that constitutes the first CPU core 10 performs this operation. In general, as a low-speed MOS transistor has a high threshold voltage (Vth) and a thick gate oxide film, leak current is small. Further, as the second CPU core 20 does not have a complicated function for increasing the speed of arithmetic processing, the circuit area of the second CPU core 20 is smaller than that of the first CPU core 10. The memory unit 21 is a high-speed shared cache memory for temporarily storing the information of the main memory unit 9. A power switch SWC2 is provided in the second CPU core unit C2 and is controlled to be ON/OFF by a power control signal SIG2 from the power control unit 5.

As described above, the first CPU core unit C1 has an arithmetic processing capacity higher than that of the second CPU core unit C2. Therefore, the first CPU core 10 has, for example, a maximum operating frequency greater than that of the second CPU core 20. The first CPU core 10 is composed of a MOS transistor that has, for example, a lower threshold voltage (Vth) and a thinner gate oxide film than those of the second CPU core 20 and is capable of performing an operation faster than the second CPU core 20. The first CPU core 10 has, for example, more pipeline stages than the second CPU core 20 does. The first CPU core 10 has, for example, an area larger than that of the second CPU core 20. For example, the first CPU core 10 has a complicated configuration in order to perform Out-of-Order execution, while the second CPU core 20 has a relatively simple configuration in order to perform In-Order execution. The first CPU core 10 has, for example, a power supply voltage greater than that of the second CPU core 20.

The first CPU core unit C1 and the second CPU core unit C2 can exchange information via the CPU bus 1. That is, the first CPU core unit C1 and the second CPU core unit C2 can exchange their configuration information, data processed in the CPU cores, and data stored to the memory units.

The temperature sensor 2, the temperature detection unit 3, the control unit 4, the power control unit 5, and the clock control unit 6 can exchange information via the bus 7. Further, the CPU bus 1 and the bus 7 can exchange information with each other.

The temperature sensors 2 are provided in each part of the semiconductor chip 101, particularly inside and around the first CPU core unit C1 and used to measure a temperature Tc of the first CPU core unit C1. The temperature detection unit 3 uses the temperature sensors 2 to measure the temperature Tc of the first CPU core unit C1. Then, when the temperature Tc of the first CPU core unit C1 is greater than a temperature threshold Tth1 (also referred to as a first value), the temperature detection unit 3 outputs an interrupt instruction SI1 (also referred to as a first interrupt instruction). When the control unit 4 receives the interrupt instruction ST1 from the temperature detection unit 3, the control unit 4 outputs a stop instruction SS to the first CPU core unit C1 via the bus 7 and the CPU bus 1. The power control unit 5 controls power supply to the first CPU core unit C1 and the second CPU core unit C2 using the power control signal SIG 1 and the power control signal SIG2, respectively. The clock control unit 6 controls clock signals that are supplied to the first CPU core unit C1, the second CPU core unit C2, and other functional blocks included in the semiconductor apparatus 100.

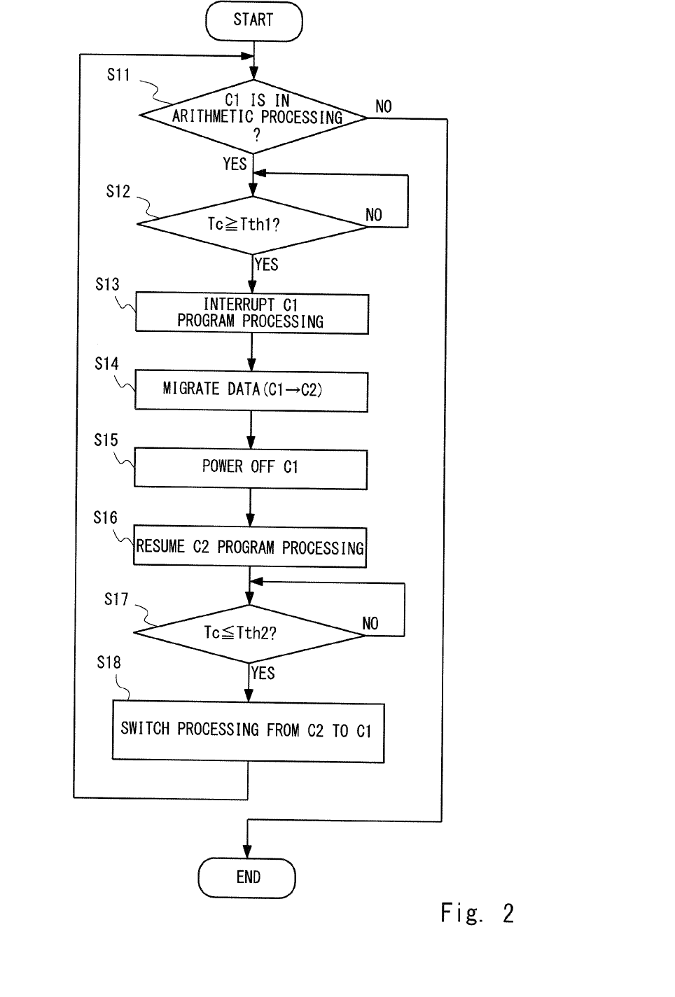

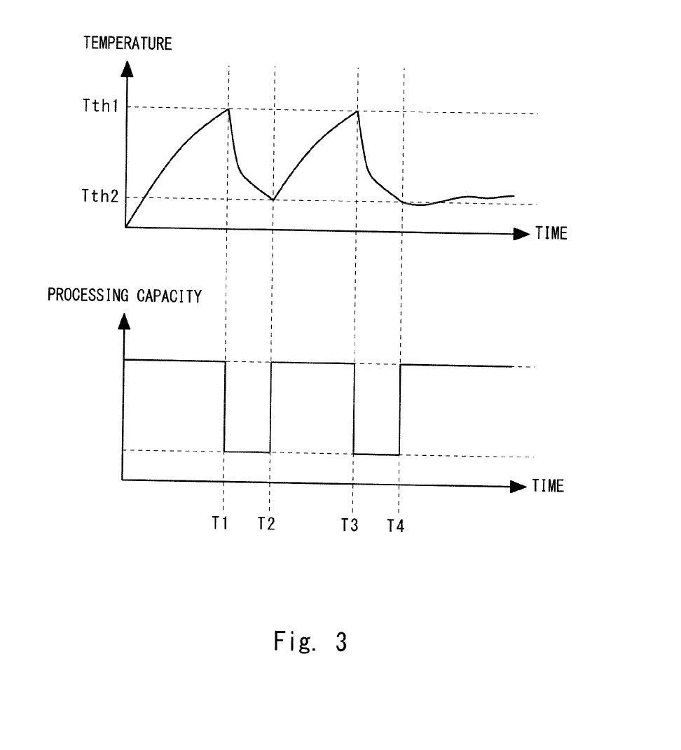

Next, an operation of the semiconductor apparatus 100 shall be explained. FIG. 2 is a flowchart showing an operation of the semiconductor apparatus 100 according to the first embodiment. FIG. 3 is a graph showing a relationship between a temperature of the first CPU core unit C1 and processing capacity of the semiconductor apparatus 100. In a normal state, the semiconductor apparatus 100 performs program processing in the first CPU core unit C1. The normal state here indicates a state where the first CPU core unit C1 is not overheated (Tc≦Tth1). In this state, when the program processing is being executed in the first CPU core unit C1 (Step S11 in FIG. 2), the temperature detection unit 3 monitors the temperature Tc of the first CPU core unit C1.

When the temperature Tc of the first CPU core unit C1 exceeds the predetermined temperature threshold Tth1, the temperature detection unit 3 outputs the interrupt instruction SI1 to the control unit 4 (Step S12 in FIG. 2).

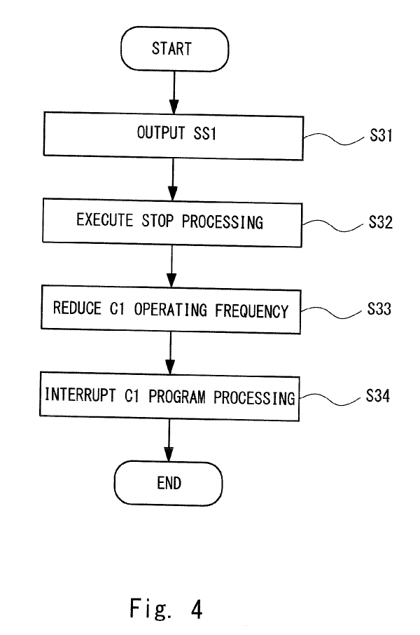

When the interrupt instruction SI1 is output, the program processing is switched from the first CPU core unit to the second CPU core unit by an instruction from the control unit 4. Firstly, the program processing in the first CPU core unit C1 is interrupted (Step S13 in FIG. 2). FIG. 4 is a flowchart showing an interrupt procedure of the program processing in the first CPU core unit C1. The control unit 4 receives the interrupt instruction SI1 from the temperature detection unit 3 and outputs a stop instruction SS1 (also referred to as a first stop instruction) for the first CPU core unit C1 to the execution control unit 8 (Step S31 in FIG. 4).

The control unit 4 outputs the stop instruction SS1 and starts stop processing of the first CPU core unit C1 (Step S32 in FIG. 4). By executing the stop processing, the following processing is performed.

Firstly, in response to the stop instruction SS1, the clock control unit 6 reduces a frequency of a clock signal which will be supplied thereby to reduce the operating frequency of the first CPU core 10 included in the first CPU core unit C1 (Step S33 in FIG. 4). Thus, the generated heat in the first CPU core unit C1 can be suppressed. After that, the execution control unit 8 holds an internal state of the first CPU core 10 and interrupts the program processing in execution (Step S34 in FIG. 4).

Referring back to FIG. 2, an explanation of the operation of the semiconductor apparatus 100 shall be continued. After interrupting the program processing in the first CPU core 10, the execution control unit 8 migrates data from the first CPU core unit C1 to the second CPU core C2 via the CPU bus 1 (Step S14 in FIG. 2).

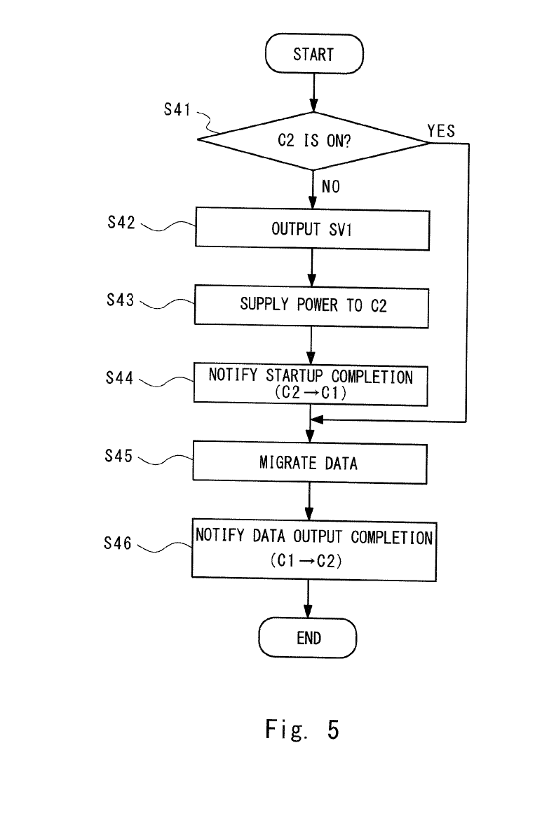

FIG. 5 is a flowchart showing a data migration procedure from the first CPU core unit C1 to the second CPU core unit C2. The execution control unit 8 queries the power control unit 5 whether or not power is supplied from the power control unit 5 to the second CPU core unit C2 (Step S41 in FIG. 5).

When the power is not supplied to the second CPU core unit C2, the execution control unit 8 outputs, to the power control unit 5, a power supply instruction SV1 (also referred to as a first power supply instruction) for instructing the execution control unit 8 to start supplying the power to the second CPU core unit C2 (Step S42 in FIG. 5). When the power is supplied to the second CPU core unit C2 from the power supply control unit 5, the process proceeds to the step S45.

The power control unit 5 receives the power supply instruction SV1 and supplies the power to the second CPU core unit C2 (Step S43 in FIG. 5). Then, the second CPU core unit C2 is started.

When the second CPU core unit C2 is started and initialization is completed, the second CPU core unit C2 notifies the execution control unit 8 that the startup is completed (this notification is also referred to as a first startup completion notification) (Step S44 in FIG. 5). In the state where the second CPU core unit C2 is started, the execution control unit 8 migrates an internal state such as data indicating configuration information of the first CPU core unit C1 and data processed in the first CPU core 10 and data stored to the memory unit 11 to the second CPU core C2 via the CPU bus 1 (Step S45 in FIG. 5). The data migration here indicates that data necessary for resuming, in the second CPU core unit C2, the program processing that is interrupted in the first CPU core unit C1 is migrated to the second CPU core unit C2.

When the output of the data which should be migrated is completed, the execution control unit 8 notifies the second CPU core unit C2 that the data output is completed (this notification is also referred to as a first output completion notification) (Step S46 in FIG. 5). In this manner, the second CPU core unit C2 can recognize that the data migration is completed.

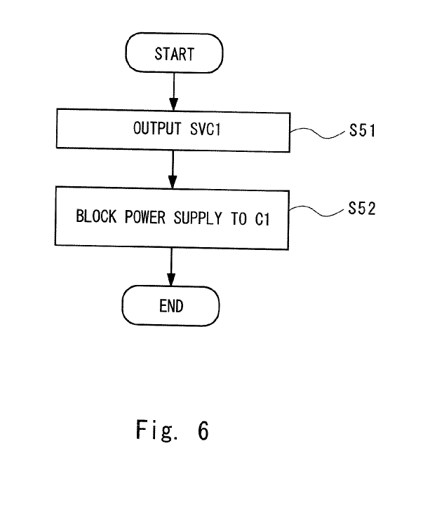

Referring back to FIG. 2, an explanation of the operation of the semiconductor apparatus 100 shall be continued. Although the operation of the first CPU core unit C1 has stopped, as the leak current still flows, the heat generation is not completely stopped. After the data migration (Step S14 in FIG. 2) is completed, the first CPU core unit C1 is powered off (Step S15 in FIG. 2). FIG. 6 is a flowchart showing a procedure to power off the first CPU core unit C1. The second CPU core unit C2 outputs, to the power control unit 5, a power block instruction SVC1 (also referred to as a first power block instruction) for instructing the power control unit 5 to block the power supply to the first CPU core unit C1 (Step S51 in FIG. 6). The power control unit 5 receives the power block instruction SVC1 and blocks the power supply by turning off the power supply switch SWC1 that is provided in the first CPU core unit C1 (Step S52 in FIG. 6). Then, the first CPU core unit C1 is powered off. As a result, the leak current flowing into the first CPU core unit C1 is blocked, and the heat generation in the first CPU core unit C1 is stopped.

Referring back to FIG. 2, an explanation of the operation of the semiconductor apparatus 100 shall be continued. After the first CPU core unit C1 is powered off (Step S15 in FIG. 2), the second CPU core unit C2 resumes the program processing based on the migrated data (Step S16 in FIG. 2 and timings T1 and T3 in FIG. 3).

As explained above, the power supply to the first CPU core unit C1 is blocked, and the leak current flowing into the first CPU core unit C1 is blocked. As a result, the heat generation in the first CPU core unit C1 is stopped, and the temperature of the first CPU core unit C1 starts to decrease.

As the temperature detection unit 3 continues to monitor the temperature Tc of the first CPU core unit C1 (Step S17 in FIG. 2), when the temperature Tc of the first CPU core unit C1 falls below a predetermined temperature threshold Tth2 (Tth2<Tth1, also referred to as a second value), the temperature detection unit 3 outputs an interrupt instruction S12 (also referred to as a second interrupt instruction).

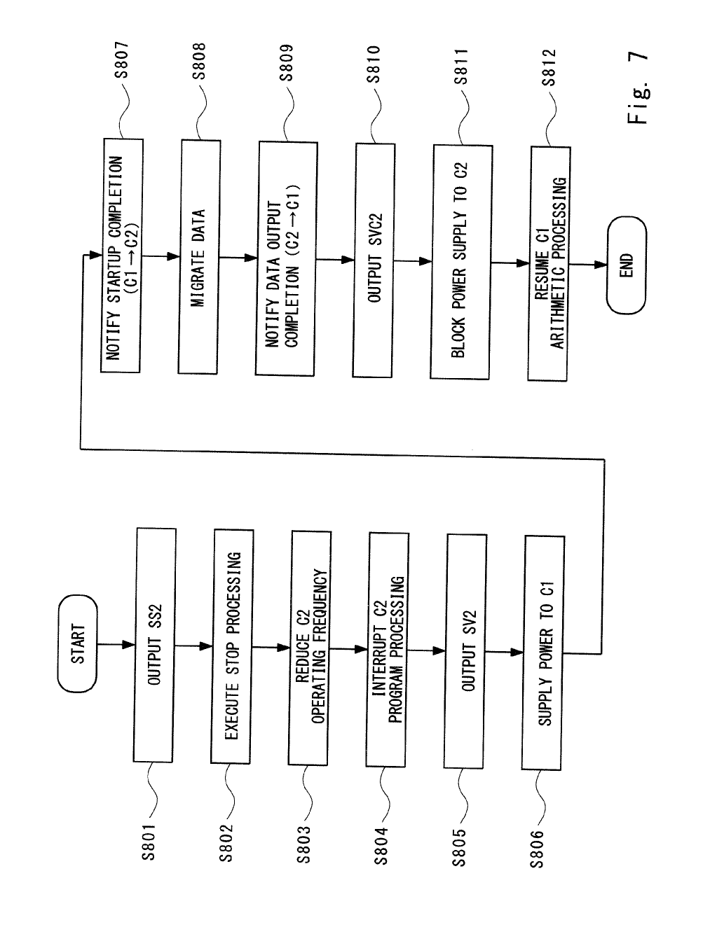

When the interrupt instruction S12 is output, the execution of the program processing is switched from the second CPU core unit C2 to the first CPU core unit C1 (Step S18 in FIG. 2). FIG. 7 is a flowchart showing a procedure to switch the execution of the program processing from the second CPU core unit C2 to the first CPU core unit C1.

The control unit 4 receives the interrupt instruction S12 and outputs a stop instruction SS2 (also referred to as a second stop instruction) for the second CPU core unit C2 to the execution control unit 8 (Step S801 in FIG. 7).

The control unit 4 outputs the stop instruction SS2 and starts stop processing of the second CPU core unit C2 (Step S802 in FIG. 7). By executing the stop processing, the following processing is performed.

Firstly, the clock control unit 6 receives the stop instruction SS2 and reduces a frequency of a clock signal which will be supplied, to thereby reduce the operating frequency of the second CPU core 20 included in the second CPU core unit C2 (Step S803 in FIG. 7). After that, the second CPU core 20 interrupts the program processing in execution (Step S804 in FIG. 7).

The execution control unit 8 outputs a power supply instruction SV2 (also referred to as a second power supply instruction) for instructing the power control unit 5 to start supplying power to the first CPU core unit C1 (Step S805 in FIG. 7). The power control unit 5 receives the power supply instruction SV2 and supplies the power to the first CPU core unit C1 (Step S806 in FIG. 7). Then, the first CPU core unit C1 is started. When the first CPU core unit C1 is started and initialization is completed, the first CPU core unit C1 notifies the execution control unit 8 that the startup is completed (this notification is also referred to as a second startup completion notification) (Step S807 in FIG. 7).

The execution control unit 8 migrates an internal state such as data indicating configuration information of the second CPU core unit C2 and data processed in the second CPU core 20 and data stored to the memory unit 21 to the first CPU core C1 via the CPU bus 1 (Step S808 in FIG. 7). The data migration here indicates that data necessary for resuming, in the first CPU core unit C1, the program processing that is interrupted in the second CPU core unit C2 is migrated to the first CPU core unit C1.

When the output of the data which should be migrated is completed, the execution control unit 8 notifies the first CPU core unit C1 that the data output is completed (this notification is also referred to as a second output completion notification) (Step S809 in FIG. 7). In this manner, the second CPU core unit C2 can recognize that the data migration is completed. After that, the first CPU core unit C1 outputs, to the power control unit 5, a power block instruction SVC2 (also referred to as a second power block instruction) for instructing the power control unit 5 to block the power supply to the second CPU core unit C2 (Step S810 in FIG. 7). Then, the power supply to the second CPU core unit C2 is blocked (Step S811 in FIG. 7), and the second CPU core unit C2 is stopped.

After that, the first CPU core unit C1 resumes the program processing based on the migrated data (Step S812 in FIG. 7 and timings T2 and T4 in FIG. 3). Thus, high-speed program processing is resumed.

As described above, according to this embodiment, when the temperature Tc of the first CPU core unit C1 exceeds the temperature threshold Tth 1, the program processing in the first CPU core unit C1 is stopped, thereby reducing the temperature of the first CPU core unit C1. After that, when the temperature Tc of the first CPU core unit C1 falls below the temperature threshold Tth2 (Tth2<Tth1), the program processing in the first CPU core unit C1 can be resumed. Therefore, even when the first CPU core unit C1 is overheated during the program processing, it is possible to surely prevent the thermal runaway of the first CPU core unit C1.

Further, while the program processing in the first CPU core unit C1 is stopped, the second CPU core unit C2 resumes the program processing that has been processed halfway by the first CPU core unit C1 and continues to execute the program processing. Therefore, although the processing capacity of the second CPU core unit C2 is lower than that of the first CPU core unit C1, the second CPU core unit C2 can continue the program processing at a constant pace. At the time of switching between the first CPU core unit C1 and the second CPU core unit C2, data is exchanged via a dedicated CPU bus. Thus, it is not necessary to change an operating system and an application program etc. Accordingly, it is possible to more effectively prevent the arithmetic processing capacity from deteriorating than in the case of stopping the program processing in the CPU unit once and re-executing the program processing from the beginning after the CPU is switched.

### Second Embodiment

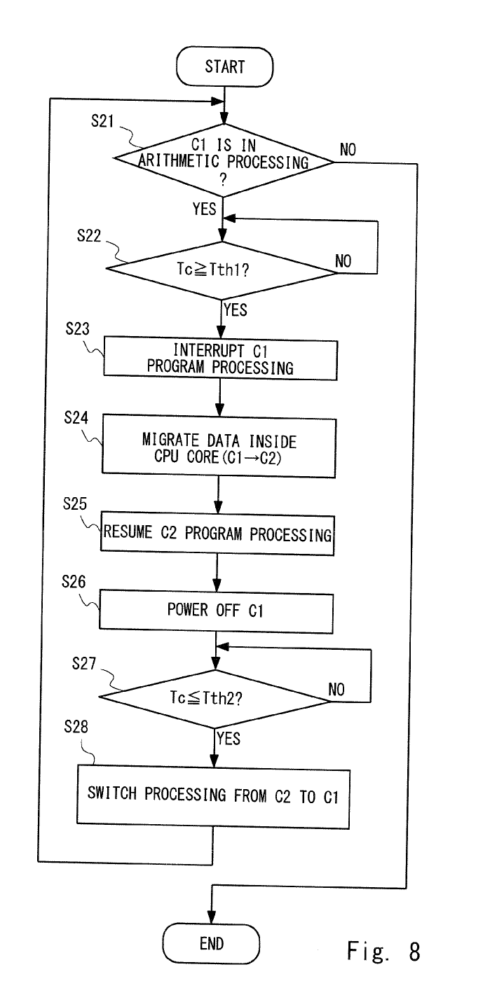

An operation of a semiconductor apparatus 200 according to the second embodiment shall be explained. FIG. 8 is a flowchart showing an operation of the semiconductor apparatus 200 according to the second embodiment. As Steps S21 to S23 are similar to Steps S11 to S13 in FIG. 2, respectively, an explanation of the Steps S21 to S23 shall be omitted.

After the program processing in the first CPU core 10 is interrupted, the execution control unit 8 migrates an internal state such as data indicating configuration information of the first CPU core unit C1 and data processed in the first CPU core 10 from the first CPU core unit C1 to the second CPU core unit C2 (Step S24 in FIG. 8).

The second CPU core unit C2 resumes the program processing based on the migrated data (Step S25 in FIG. 8).

At this point, when it is necessary to access the data held in the memory unit 11 of the first CPU core unit C1, the second CPU core 20 can continue to access the memory unit 11 of the first CPU core unit C1 via the CPU bus 1. When it is necessary to access a new main memory, data in the main memory is cached in the memory unit 21 of the second CPU core unit C2. In this manner, when the access to the memory unit 11 of the first CPU core unit C1 becomes unnecessary, the first CPU core unit C1 is powered off (Step S26 in FIG. 8).

As subsequent Steps S27 and S28 are similar to Steps S17 and S18 in FIG. 2, respectively, an explanation of Steps S27 and S28 shall be omitted.

In this embodiment, it is not necessary to wait for the data to be copied from the memory unit 11 of the first CPU unit C1 to the memory unit 21 of the second CPU core unit C2 before resuming the execution of the program. Accordingly, the time period when the program processing is interrupted becomes shorter, and it is thus possible to more effectively prevent an arithmetic processing capacity from deteriorating than in the first embodiment.

### Third Embodiment

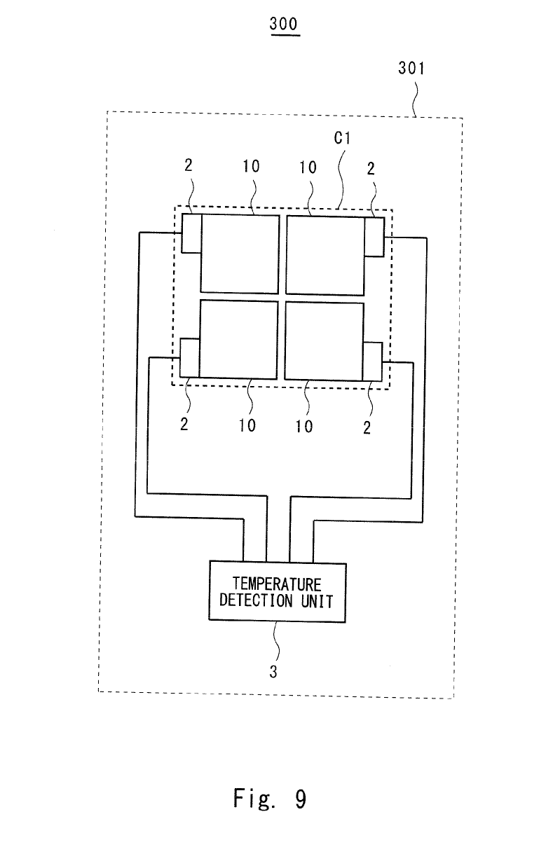

Next, a semiconductor apparatus 300 according to a third embodiment shall be explained. FIG. 9 is a block diagram schematically showing a configuration of the semiconductor apparatus 300 according to the third embodiment. FIG. 9 illustrates a case where the first CPU core unit C1 includes four first CPU cores 10. Note that in order to simplify the drawing, FIG. 9 illustrates only the first CPU core unit C1, the first CPU cores 10, the temperature sensors 2, and the temperature detection unit 3. In FIG. 9, the first CPU core unit C1, the first CPU cores 10, the temperature sensors 2, and the temperature detection unit 3 are formed on the same semiconductor chip 301.

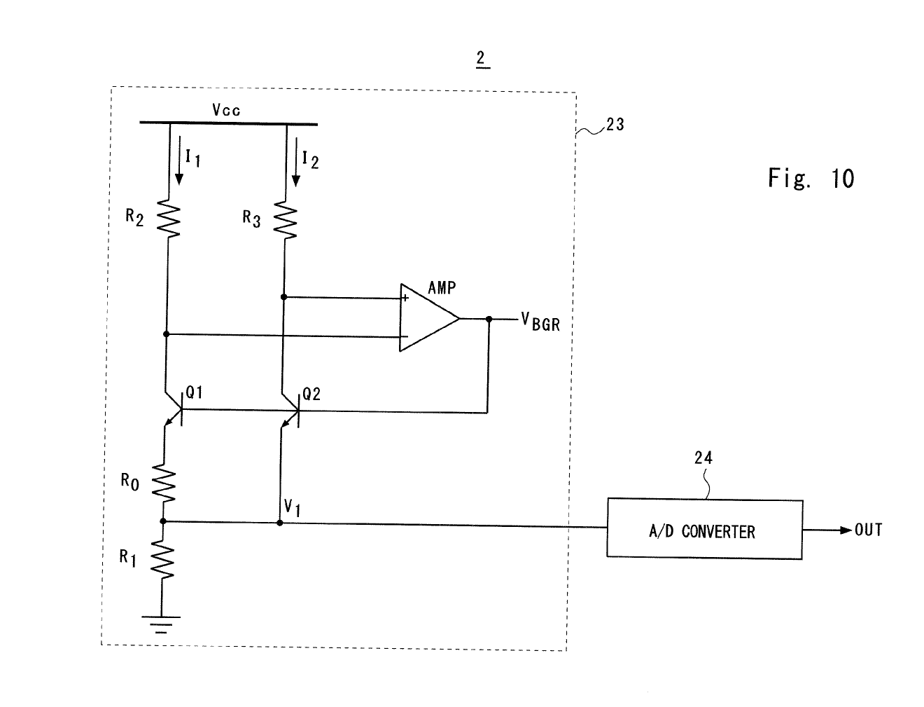

FIG. 10 is a circuit diagram showing a configuration example of the temperature sensor 2 that is configured using a bandgap circuit. In this example, a bandgap circuit 23 is composed of resistors R₀ to R₃, transistors Q1 and Q2, and an operation amplifier AMP. The resistor R₂, the transistor Q1, and the resistors R₀ and R₁ are connected in series in this order between power supply that outputs a power supply voltage Vcc (hereinafter, the power supply is also referred to as power supply Vcc) and the ground. Current I₁ flows through a path composed of the resistor R₂, the transistor Q1, and the resistors R₀ and R₁. The resistor R₃ and the transistor Q2 are connected in series in this order between the power supply Vcc and a node between the resistors R₀ and R₁. Current I₂ flows through a path composed of the resistor R₃ and the transistor Q2.

The node (a voltage V₁) between the resistors R₀ and R₁ is connected to an external A/D converter 24. As for the operational amplifier AMP, a non-inverting input terminal is connected to a node between the resistor R₂ and the transistor Q1, while an inverting input terminal is connected to a node between the resistor R₃ and the transistor Q2. An output terminal of the operational amplifier AMP is connected to the bases of the transistors Q1 and Q2 and outputs a bandgap reference voltage V_{BGR}. The A/D converter 24 outputs an output signal OUT, which is obtained by converting the voltage V₁ from analog to digital (A/D).

In this embodiment, by converting, using the A/D converter 24, the voltage V1 that is proportional to an absolute temperature generated by the bandgap circuit 23 into a digital value, it is possible to detect the temperature of the first CPU core unit C1 and control the semiconductor apparatus 300.

When four temperature sensors 2 are provided in each of the four first CPU cores 10 and any one of the temperature sensors exceeds a temperature Tth11, control is performed to switch between the first CPU core unit and the second CPU core unit. Further, it is possible to combine appropriate types of control based on the temperatures of the four temperature sensors such that the first CPU core unit and the second CPU core unit are switched when an average value of the temperatures of the four temperature sensors exceeds a temperature Vth 12, which is lower than a temperature Vth11.

In the semiconductor apparatus 300, the temperature sensors 2 are disposed in proximity to the first CPU core C1. Thus, it is possible to dispose the temperature sensors 2 without changing the shape and the location of the first CPU core unit C1. Further, the temperature sensors 2 can detect the temperature of the first CPU core unit C1 with a small amount of delay from a change in the temperature, thereby preventing the thermal runaway of the first CPU core unit C1.

### Fourth Embodiment

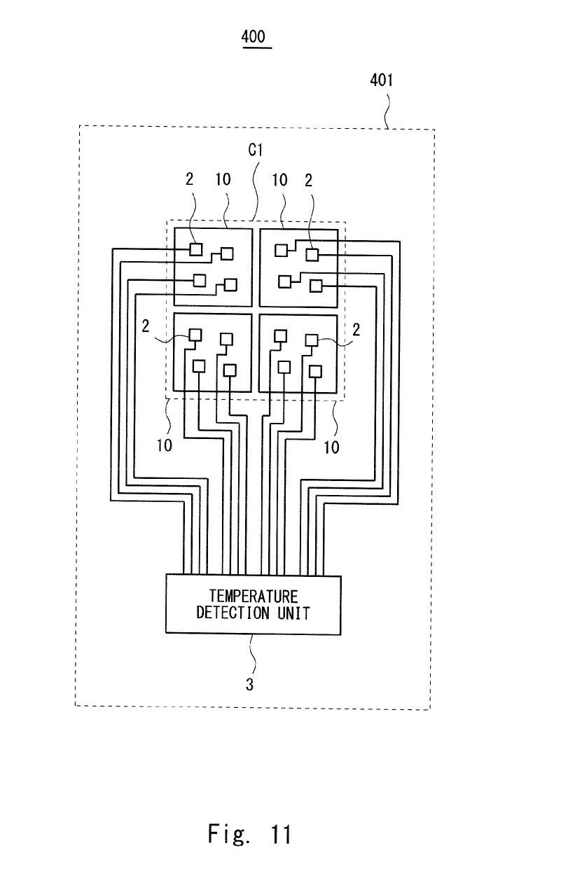

Next, a semiconductor apparatus 400 according to a fourth embodiment shall be explained. FIG. 11 is a block diagram schematically showing a configuration of the semiconductor apparatus 400 according to the fourth embodiment. FIG. 11 illustrates a case where the first CPU core unit C1 includes four first CPU cores 10. Note that in order to simplify the drawing, FIG. 11 illustrates only the first CPU core unit C1, the first CPU cores 10, the temperature sensors 2, and the temperature detection unit 3. In FIG. 11, the first CPU core unit C1, the first CPU cores 10, the temperature sensors 2, and the temperature detection unit 3 are formed on the same semiconductor chip 401.

In the semiconductor apparatus 400, four temperature sensors 2 are distributed and disposed inside each of the first CPU core unit C1. The temperature sensor 2 is preferably disposed in a functional block with a large increase in the temperature in the first CPU core unit. Thus, it is possible to detect a temperature of a section with the highest temperature even when the amount of temperature increase differs from a functional block to a functional block inside the first CPU core unit C1 and the temperatures are distributed among the functional blocks. Accordingly, the semiconductor apparatus 400 can detect the temperature of the first CPU core unit C1 more accurately and with a smaller amount of delay from a change in the temperature than the semiconductor apparatus 300 can.

### Other Embodiment

Note that the present invention is not limited to the above-described embodiments, and modifications can be made as appropriate without departing from the scope thereof. For example, the number of the temperature sensors 2 in the second and third embodiments is merely an example and may be any number.

Although the invention made by the present inventors has been explained based on the embodiments, it is obvious that the present invention is not limited to the already-described embodiments and various modifications can be made within the range not departing from the scope.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A semiconductor apparatus comprising:
a first processing unit that executes a binary program;
a second processing unit that is capable of executing the binary program the same as the binary program executed by the first processing unit;
a temperature sensor that measures a temperature of the first processing unit;
a temperature detection unit that outputs a first interrupt instruction when the temperature measured by the temperature sensor exceeds a first value;
a bus that exchanges data between the first processing unit and the second processing unit;
a control unit that, in response to the first interrupt instruction, interrupts execution in the first processing unit, migrates first data from the first processing unit to the second processing unit, and controls the second processing unit to resume the execution of the binary program, the first data being necessary for resuming the execution of the binary program; and
a power control unit that blocks power supply to the first processing unit after the first data is migrated to the second processing unit.

2. The semiconductor apparatus according to claim 1, wherein
when the control unit receives the first interrupt instruction, the control unit outputs a first stop instruction,
the first processing unit
interrupts the execution of the binary program after receiving the first stop instruction,
outputs the first data to the second processing unit via the bus, and
outputs a first output completion notification to the second processing unit when the output of the first data is completed,
when the second processing unit receives the first output completion notification, the second processing unit outputs a first power block instruction to the power control unit, and
when the power control unit receives the first power block instruction, the power control unit blocks the power supply to the first processing unit.

3. The semiconductor apparatus according to claim 2, wherein
when the first processing unit receives the first stop instruction, the first processing unit queries the power control unit about power supply to the second processing unit, and when the power supply to the second processing unit is blocked, the first processing unit outputs a first power supply instruction to the power control unit,
when the power control unit receives the first power supply instruction, the power control unit starts the power supply to the second processing unit,
when startup of the second processing unit is completed after the power supply is started, the second processing unit outputs a first startup completion notification to the first processing unit, and
when the first processing unit receives the first startup completion notification, the first processing unit starts outputting the first data.

4. The semiconductor apparatus according to claim 1, wherein the first processing unit reduces an operating frequency of the first processing unit prior to the interruption of the execution of the binary program.

5. The semiconductor apparatus according to claim 2, wherein
after the first interrupt instruction is output, the temperature detection unit outputs a second interrupt instruction when the temperature measured by the temperature sensor falls below a second value that is lower than the first value, and
when the control unit receives the second interrupt instruction, the control unit outputs a second stop instruction.

6. The semiconductor apparatus according to claim 5, wherein
the second processing unit
interrupts the execution of the binary program after the second processing unit receives the second stop instruction, and
outputs a second power supply instruction to the power control unit,
when the power control unit receives the second power supply instruction, the power control unit starts the power supply to the first processing unit,
when startup of the first processing unit is completed after the power supply is started, the first processing unit outputs a second startup completion notification to the second processing unit,
the second processing unit
outputs second data to the first processing unit via the bus after the second processing unit receives the second startup completion notification, the second data being necessary for resuming the execution of the binary program, and
outputs a second output completion notification to the first processing unit when the output of the second data is completed,
when the first processing unit receives the second output completion notification, the first processing unit outputs a second power block instruction to the power control unit, and
when the power control unit receives the second power block instruction, the power control unit blocks the power supply to the second processing unit.

7. The semiconductor apparatus according to claim 6, wherein
the second processing unit reduces an operating frequency of the second processing unit prior to the interruption of the execution of the binary program.

8. The semiconductor apparatus according to claim 1, wherein
the first processing unit includes one or a plurality of first CPU cores, and
the second processing unit includes one or a plurality of second CPU cores.

9. The semiconductor apparatus according to claim 8, wherein
one or a plurality of the temperature sensors are disposed in proximity to the first CPU core.

10. The semiconductor apparatus according to claim 8, wherein
one or a plurality of the temperature sensors are disposed inside the first CPU core.

11. The semiconductor apparatus according to claim 10, wherein
the one or the plurality of temperature sensors are distributed and disposed inside the first CPU core.

12. A method of controlling a semiconductor apparatus comprising:
outputting a first interrupt instruction when a temperature of a first processing unit exceeds a first value, the first processing unit executing a binary program;
interrupting the execution of the binary program in the first processing unit after outputting the first interrupt instruction;
migrating first data necessary for resuming the execution of the binary program to a second processing unit, the second processing unit generating heat lower than that in the first processing unit;
resuming, in the second processing unit, the execution of the binary program; and
blocking power supply to the first processing unit after migrating the first data to the second processing unit.

13. The method according to claim 12, wherein
an operating frequency of the first processing unit is reduced prior to the interruption of the execution of the binary program.

14. The method according to claim 12, wherein
after the first interrupt instruction is output, a second interrupt instruction is output when the temperature of the first processing unit falls below a second value, which is lower than the first value.

15. The method according to claim 14, wherein after the second interrupt signal is output,
the execution of the binary program in the second processing unit is interrupted,
the power supply to the first processing unit is resumed,
second data is migrated from the second processing unit to the first processing unit, the second data being necessary for resuming the execution of the binary program,
the first processing unit resumes the execution of the binary program, and
after the second data is migrated to the first processing unit, power supply to the second processing unit is blocked.

16. The method according to claim 15, wherein
an operating frequency of the second processing unit is reduced prior to the interruption of the execution of the binary program.
